(19) United States
(12) Patent Application Publication
(10) Pub. No.: US 2024/0160580 A1
(43) Pub. Date: May 16, 2024

(54) VIRTUAL EXTENSION TO GLOBAL ADDRESS SPACE AND SYSTEM SECURITY

(71) Applicant: Intel Corporation, Santa Clara, CA (US)

(72) Inventors: Gurpreet Singh KALSI, Portland, OR (US); Joshua FRYMAN, Corvallis, OR (US); Jason HOWARD, Portland, OR (US); Robert PAWLOWSKI, Beaverton, OR (US)

(21) Appl. No.: 18/333,750

(22) Filed: Jun. 13, 2023

Related U.S. Application Data
(60) Provisional application No. 63/424,308, filed on Nov. 10, 2022.

(51) Int. Cl. G06F 12/109; G06F 9/50

(52) U.S. Cl. CPC G06F 12/109; G06F 9/5016; G06F 2212/657

(57) ABSTRACT

This disclosure describes systems, methods, and devices related to a global address space (VEGAS) approach. The device may execute at least two processes within a device in a computing environment, each process running on a respective compute block of at least two compute blocks. The device may manage allocations of virtual memory spaces for the least two compute blocks using an independent logical system separate from the at least two compute blocks. The device may isolate the virtual memory spaces of the at least two processes by allowing each compute block to access only its own allocated virtual memory space.

### CROSS-REFERENCE TO RELATED APPLICATION(S)

This application claims the benefit of U.S. Provisional Application No. 63/424,308, filed Nov. 10, 2022, the disclosure of which is incorporated herein by reference as if set forth in full.

### TECHNICAL FIELD

This disclosure generally relates to systems and methods for wireless communications and, more particularly, to virtual extension to Global Address Space (VEGAS) and system security.

### BACKGROUND

The ever-increasing demand for efficient and secure computing systems has resulted in the rapid advancement of processing technology and architecture. Modern computing systems are required to perform complex tasks while maintaining data integrity and security. In a computing environment, various tasks or processes often run concurrently, sharing the same hardware resources such as memory, processing units, and network interfaces. Ensuring that these tasks operate independently and securely from one another is critical to prevent unauthorized access to sensitive data or malicious activities, such as side channel attacks.

### BRIEF DESCRIPTION OF THE DRAWINGS

FIGS. 1-2 depict illustrative schematic diagrams for a virtual extension to Global Address Space (VEGAS) system, in accordance with one or more example embodiments of the present disclosure.

FIG. 3 illustrates a flow diagram of a process for an illustrative computing system, in accordance with one or more example embodiments of the present disclosure.

FIG. 4 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The need for Global Address Space on large scale multi-core systems is addressed using system and software libraries. Application user awareness of system memory space provides hooks to exploit it and breach security solutions. Hardware solution for Virtual Extension to Global Address Space is never attempted, it can provide hardware security on a global address space (GAS) architecture.

GAS is a memory architecture used in parallel and distributed computing systems where all the memory locations across multiple processing nodes can be directly accessed by any processor in the system without the need for explicit message passing or data copying. In other words, the memory of each processing node is combined into a single, unified address space, allowing processors to read and write data from any location as if it were local memory.

This shared-memory model simplifies the programming of parallel and distributed systems by providing a more intuitive way to manage data access and communication between processing nodes. However, implementing a GAS architecture comes with challenges, such as ensuring data consistency, managing memory latency, and maintaining security, as all processors can potentially access any memory location in the system.

The responsibility of security in a GAS architecture is typically placed on the software implementation by partitioning the address map among the various user jobs, system, and kernel spaces. Hardware approaches are limited and exist more as support methods for implementing software security. One example is by designing regions in the address specifically for users, kernel, and system to guide software usage. In addition, some previous hardware solutions include minor protection checks but do not provide extensive protection to isolate memory regions among different user jobs.

Software security solutions incur a significant amount of overhead for the programmer and will affect the total performance of an application. Additionally, software-only security leaves the hardware exposed to various physical inspection methods. Limited hardware guidance leaves significant security holes, as it alone does not protect user code and data regions from other users (or kernel/system software).

Example embodiments of the present disclosure relate to systems, methods, and devices for a virtual extension to global address space (VEGAS) and system security.

In one or more embodiments, a VEGAS system may provide a mechanism to perform isolated job execution without interfering with standard software tools and models. The VEGAS system provides memory region to a “job” within a global address space which is only visible/accessible to that job. Compute blocks associated with the job can access unencrypted data within an assigned memory region whereas it remains encrypted to all other resources in the system. While part of the global address space is visible to the compute logic, security aspects are managed outside using VEGAS logic. Resources associated with a job have no visibility to the physically mapped memory which prevents side channel attacks. The VEGAS system approach provides a scalable security solution for systems implementing a global address space (GAS). Previous hardware solutions implementing memory region protections within the address map, or a basic supervisor mode provide only limited security and can be easily bypassed. The VEGAS system provides an end-to-end system solution that fully protects memory ranges for the duration of a job's existence.

The VEGAS system is a versatile computing architecture that can be applied to a wide range of applications, from small form factor devices to supercomputing systems. This disclosure focuses on a single-node office server setup, which includes compute resources, memory (DRAM), and non-volatile memory (NVM) connected via industry-standard interfaces such as NVMe. However, this may apply to other server setups.

Some of the components of the VEGAS system may include:

Compute resources: Represented as compute slices, these computing cores can be based on various architectures such as x86, ARM, or RISC-V.

Memory: This includes DRAM and NVM, which store and manage data within the system.

Network: Multiple network levels connect the resources and memories within the system, although the VEGAS architecture can also be applicable to just one level of the network.

Accelerators: Referred to as Memory Processing Units (MPUs), these specialized components provide specific acceleration for certain functions.

The VEGAS system allows users to access all resources, with security provisions typically implemented in software. However, the VEGAS system introduces dedicated hardware support for improved security and isolation. When a user runs a job on the VEGAS system, resources such as compute slices, memory regions, and external connectivity are allocated by a centralized scheduler. The VEGAS system ensures that data is visible only to the specific job and protected from unauthorized access, even if network transactions pass through other resources.

The VEGAS system provides compartmentalization and isolation for jobs running on the platform, ensuring data security and efficient resource allocation.

In one or more embodiments, a VEGAS system may provide process isolation from all other processes using metadata attached to the virtual address space, with address translation handled outside the compute block. It should be understood that compute block is a term used to describe any computing unit or structure within the VEGAS system. It may refer to a compute slice, a Compute Complex Tile (CCT), or any other computing element within the system.

In one or more embodiments, a VEGAS system may facilitate that compute blocks can access their own allocated virtual memory space without exposure to physical address mapping, preventing side channel attacks.

In one or more embodiments, a VEGAS system may facilitate that the VEGAS logic placed near-memory compute blocks performs data decryption and encryption for atomic compute operations and security checks for data handling.

In one or more embodiments, a VEGAS system may facilitate that the VEGAS block at the network boundary performs security checks, metadata decoding, address interleaving, metadata encryption and decryption, metadata compression and decompression, and resource access pattern detection.

In one or more embodiments, a VEGAS system may provide a scalable directory structure connected to the socket network for coherency in the memory region of interest, with VEGAS logic within the directory structure to prevent unrelated jobs from accessing cache information.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

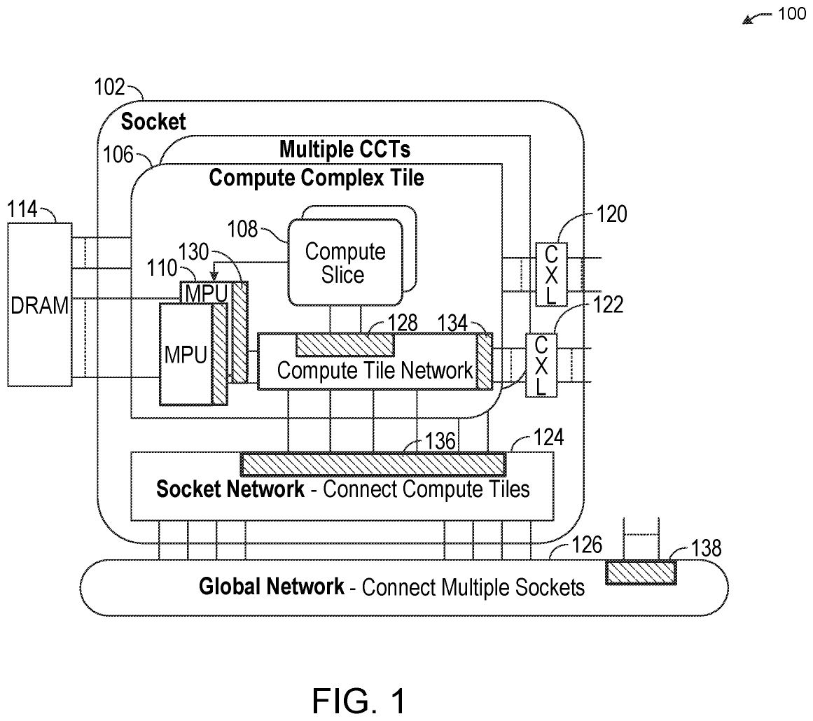

FIG. 1 depicts an illustrative schematic diagram for a VEGAS system, in accordance with one or more example embodiments of the present disclosure.

Referring to FIG. 1, there is shown a conceptual view of a system with VEGAS components. A Compute Slice (108) represents the programmable compute engines with the capability to boot the operating system and run processes. The Memory Processing Unit (MPU, 112) consists of a memory controller, atomic compute support, and data manipulation operations. The Compute Complex Tile (CCT, 106) is composed of multiple compute slices and MPUs connected over a local network. A socket (102) comprises multiple CCTs (106) connected using a socket network (124) and these can communicate to other system components using CXL (120 and/or 122), PCIe, or similar interfaces. Multiple sockets can be connected using a Global network (126) which also has processing units connected to them like Xeon or similar cores with security features. The VEGAS block (130, 134, 136, and 138) is responsible for performing: (a) Virtual address translation; (b) Job isolation by allowing jobs mapped to specific resources only; (c) Metadata field management (decryption, encryption, compression); (d) Data decryption and encryption; and (e) Access rule checks and security management.

A process initiated on a secure system connected to the proposed VEGAS system or launched from a compute tile within the VEGAS system will generate the secure task ID linked to that process. This task-ID is securely delivered to VEGAS blocks (130, 134, 136, or 138) through the encrypted channel to mark address space and rules associated with task-ID protection.

In the VEGAS system, process isolation may be achieved by attaching metadata to the virtual address space of each process. This metadata is invisible to the compute tile, ensuring that each process remains separate from others. For example, consider two processes, A and B, running on the system. The VEGAS system assigns unique metadata to each process, ensuring that they cannot inadvertently access each other's resources, thereby maintaining isolation and security.

Process isolation is an important aspect of the VEGAS system, as it ensures that different processes running on the system do not interfere with each other or access each other's resources. To achieve this, the VEGAS system employs metadata attached to the virtual address space of each process. For example, for every process running on the system, the VEGAS system associates metadata with its virtual address space. This metadata contains information about the process, such as its permissions, privileges, and access restrictions. By attaching metadata to the virtual address space, the VEGAS system can enforce isolation between processes and control access to resources.

The metadata associated with a process's virtual address space is not visible to the compute tile. Instead, the address translation, which maps virtual addresses to physical addresses, is handled outside the compute block by the VEGAS logic. This ensures that the compute block cannot access or manipulate the metadata, which could lead to potential security vulnerabilities.

The VEGAS system enforces process isolation by leveraging the metadata associated with each process's virtual address space. When a compute block requests access to a resource, the VEGAS logic checks the metadata to determine if the block is authorized to access the resource. If the compute block is not authorized, the VEGAS logic denies access, thereby preventing unauthorized interactions between processes. For example, assuming there are two processes, A and B, running on the VEGAS system. Each process has its own metadata associated with its virtual address space, dictating the resources it can access. When process A attempts to access a resource reserved for process B, the VEGAS logic checks the metadata and recognizes that process A is not authorized to access the resource. As a result, the VEGAS logic denies the access request, effectively isolating the processes and ensuring the integrity and security of the system.

By using metadata attached to the virtual address space, the VEGAS system can effectively isolate processes running on the system, protecting sensitive data and resources from unauthorized access and potential security threats.

In the VEGAS system, compute blocks can access their own allocated virtual memory space without being exposed to physical address mapping. This design choice prevents side channel attacks by minimizing the compute block's knowledge of physical memory. For instance, a compute block may be responsible for processing sensitive data. By ensuring that the block cannot access the physical memory mapping, the VEGAS system minimizes the risk of an attacker exploiting side-channel vulnerabilities to access this sensitive information.

Each compute block in the VEGAS system is assigned its own virtual memory space. This virtual memory space is separate from other compute blocks, ensuring that each block operates independently and securely within its own allocated memory.

The VEGAS logic is situated outside of the compute block's boundary and is responsible for translating virtual addresses to physical addresses. By keeping the VEGAS logic separate from the compute block, the system ensures that compute blocks do not have direct access to the physical address mapping. This separation minimizes the risk of security vulnerabilities that could arise if compute blocks were aware of the physical memory layout.

Before a compute block posts data on the system network, the VEGAS logic handles the address translation and virtual extension. This process ensures that the compute block only deals with virtual addresses, remaining unaware of the actual physical memory locations.

The lack of knowledge about physical memory in compute blocks helps prevent side channel attacks. In a side channel attack, an attacker could exploit the knowledge of physical memory layout to infer sensitive information about other processes running on the system. By ensuring that compute blocks only have access to their own virtual memory space, the VEGAS system effectively mitigates the risk of such attacks.

For example, assuming there are two compute blocks, X and Y, each assigned their own virtual memory space. When compute block X needs to access a resource, it uses a virtual address associated with its own memory space. The VEGAS logic translates this virtual address to the corresponding physical address, allowing compute block X to access the resource without ever being exposed to the physical memory layout. If an attacker tries to exploit compute block X's knowledge to gain information about compute block Y's memory, they will be unsuccessful because compute block X only has access to its own virtual memory space and is unaware of the physical memory layout.

By maintaining a separation between compute blocks and physical address mapping, the VEGAS system effectively secures the memory access process, significantly reducing the risk of side channel attacks and ensuring the overall security of the system.

In one or more embodiments, the VEGAS block/logic (e.g., 130) is strategically placed adjacent to the MPU in near-memory compute blocks. Some of the functions of the VEGAS block may include:
a) Data decryption and encryption for atomic compute operations: Atomic compute operations are indivisible and uninterruptible tasks that must be executed in their entirety to ensure data consistency and accuracy. The VEGAS logic plays a crucial role in securing these operations by handling the decryption and encryption of data. When a compute block receives encrypted data, the VEGAS logic decrypts the data before the atomic compute operation is performed. Once the operation is complete, the VEGAS logic re-encrypts the data before it is sent back to the memory or shared with other compute blocks. This process ensures that sensitive data remains secure while being processed, as only authorized compute blocks can access and decrypt the data. For example, assuming a compute block is tasked with performing an atomic operation on encrypted financial data. The VEGAS logic decrypts the data so that the compute block can execute the operation. After the operation is complete, the VEGAS logic encrypts the data again, ensuring that the processed data remains secure.
b) Security checks to authenticate data handling: In addition to data encryption and decryption, VEGAS logic also performs security checks to verify the legitimacy of data handling operations. These checks help to ensure that only authorized and authenticated operations can access or manipulate data within the system.

By combining data decryption/encryption with security checks, the VEGAS logic adds a robust layer of security to near-memory compute blocks, safeguarding sensitive data and ensuring that only authorized operations can access and manipulate the data.

The VEGAS block, situated at the network boundary, serves as a security gatekeeper by performing multiple critical functions. Its primary purpose is to ensure that data and metadata transmitted over the network are secure, reliable, and compliant with the established rules. Some of the functions of the VEGAS block may include:
a) Security checks on network packets: The VEGAS block inspects incoming and outgoing network packets to verify their authenticity. Packets that fail authentication are discarded (thrashed) and an acknowledgment is sent back to the sender. This process helps to maintain the integrity of the system and prevents unauthorized access or data tampering.
b) Metadata decode and rule checks: The VEGAS block decodes metadata associated with network packets and checks whether the packets comply with predefined rules. This step ensures that only legitimate packets are allowed to pass through the system, minimizing the risk of malicious activities or data breaches.
c) Address interleaving as programmed by the process: The VEGAS block is responsible for address interleaving, which rearranges memory addresses in a specific pattern as programmed by the process. This function helps to optimize memory access, reduce latency, and improve overall system performance.
d) Metadata encryption and decryption for secure transmission over the network: The VEGAS block encrypts metadata before it is transmitted over the network, ensuring that sensitive information is protected from eavesdropping or interception. Similarly, when receiving metadata, the VEGAS block decrypts it so that the system can process and interpret the information.
e) Metadata compression and decompression: To reduce the amount of data transmitted over the network and improve efficiency, the VEGAS block compresses metadata before sending it. Upon receipt, the VEGAS block decompresses the metadata, enabling the system to interpret and utilize the information.
f) Detecting resource access patterns and blocking transactions if rules do not allow them: The VEGAS block monitors resource access patterns to identify and block any transactions that violate established rules. This functionality helps to prevent side-channel attacks that might occur by repeatedly accessing a system resource (hammering).

For example, assuming a compute block wants to send data to another compute block within the system. Before the data is transmitted, the VEGAS block checks the packet's security, decodes and verifies the metadata, and interleaves the addresses as programmed. It also encrypts and compresses the metadata to ensure secure and efficient transmission. On the receiving end, the VEGAS block decrypts and decompresses the metadata, verifies that the packet complies with the rules, and monitors resource access patterns to prevent potential side-channel attacks.

By performing these critical functions at the network boundary, the VEGAS block plays a pivotal role in maintaining the security and integrity of the system, ensuring that data and metadata are securely transmitted and processed according to established rules and protocols.

The VEGAS system employs a scalable directory structure connected to the socket network to perform coherency for the memory region of interest. This structure incorporates VEGAS logic to prevent unrelated jobs, identified using unique Job-IDs, from accessing cache information. For instance, if two jobs with different Job-IDs are running on the system, the VEGAS logic ensures that they cannot access each other's cache information, maintaining separation and security between unrelated jobs.

Memory coherency is important for maintaining data consistency across various memory locations when multiple compute blocks are accessing and modifying the data. The directory structure is responsible for tracking the memory regions of interest and ensuring that the most up-to-date data is available to the compute blocks.

The VEGAS logic integrated within the directory structure adds an extra layer of security to the system by preventing unrelated jobs from accessing cache information. Each job running on the system is assigned a unique Job-ID, which serves as an identifier for that specific job. The VEGAS logic uses these Job-IDs to differentiate between jobs and enforce access control rules.

By monitoring and controlling access to cache information, the VEGAS logic helps prevent unauthorized access and potential security breaches. This security measure is particularly important in shared computing environments where multiple users or applications may be running simultaneously, and sensitive data must be protected from unauthorized access. For example, assuming there are two jobs, Job-A and Job-B, that are running on the VEGAS system, each with its unique Job ID. Job-A is accessing and modifying data in memory region X, while Job-B is working on memory region Y. The scalable directory structure tracks the memory regions of interest for each job and ensures data consistency across the system. The VEGAS logic within the directory structure checks the Job ID associated with each request for cache information. If a request from Job-A attempts to access cache information related to memory region Y, the VEGAS logic denies the request, preventing unauthorized access and maintaining data security.

It is understood that the above descriptions are for purposes of illustration and are not meant to be limiting.

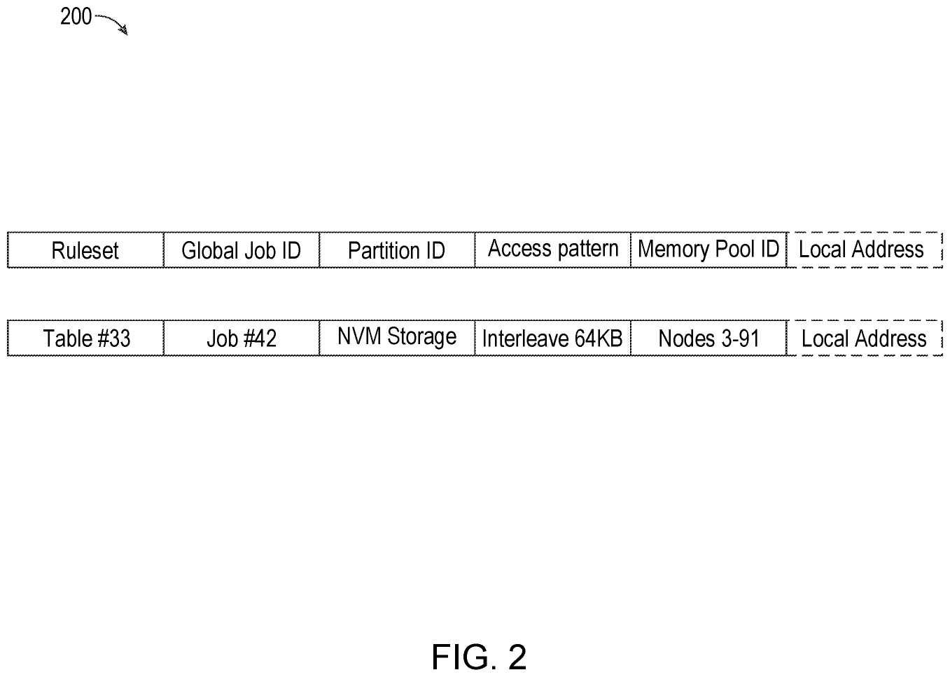

FIG. 2 depicts an illustrative schematic diagram for a VEGAS system, in accordance with one or more example embodiments of the present disclosure.

Referring to FIG. 2, there is shown an example use of VEGAS meta-data fields to isolate and secure data within one user job.

In one or more embodiments, the VEGAS system may utilize a global address space to manage memory resources, allowing different jobs to run on the system with their own unique physical address spaces. This ensures that jobs are isolated from one another and cannot access each other's memory. The global address space encompasses a wide range of memory, from zero to several petabytes or zettabytes, depending on the system's requirements. Within this global address space, multiple jobs can run concurrently, each with its own allocated memory regions.

For example, Job 1 may require a certain memory region, which can be mapped linearly within the global address space. Similarly, Job 2 might require a different amount of memory, which can also be allocated within the global address space but may not be linearly distributed.

To ensure isolation between jobs, the VEGAS system uses VEGAS blocks placed at different granularities, such as interfaces to compute resources, networks, and memory. These blocks authenticate and authorize transactions based on their associated memory spaces.

If Job 1 is running on a compute slice and makes a memory request within its allocated memory region, the VEGAS block will authorize the transaction, allowing it to pass through the network and access the required memory. However, if Job 1 makes a request outside of its allocated memory region, the VEGAS block will deny the transaction, ensuring that jobs cannot access each other's memory spaces.

In the context of the VEGAS system, the virtual address to system physical address translation occurs for what is referred to as the job physical address. Although the VEGAS system itself is not directly involved in the translation, it plays an important role in processing address spaces. The job is only aware of its own physical address space, and the VEGAS block is responsible for translating the job physical address to the system physical address. The two address spaces defined in the system are the physical address and the system physical address. Compute resources running jobs have no visibility of the system physical address space, making the system secure. Jobs only have access to their respective physical address, ensuring they remain unaware of the system's overall resources.

The VEGAS system ensures job isolation by mapping each job to specific resources. This means that if a compute slice can access a certain region of memory, the system will provide isolation, preventing two jobs from accessing each other's resources.

An important aspect of the VEGAS system is the transmission of metadata that carries necessary information for authentication. This metadata contains various attributes, such as access rules, security levels, job ID, partition ID, and access patterns, among others. The metadata is essential for encoding the transaction and ensuring secure data transfer.

Some of the VEGAS block's functions are to authenticate and send the transaction to its destination, such as DRAM. Authentication can occur either at the source or the destination. In either case, once the transaction is authenticated, the VEGAS block forms a packet with the necessary information, indicating which job the transaction belongs to, along with any applicable rules.

The data being transferred is encrypted, ensuring that no unencrypted information is transmitted over the network. Metadata encryption is also possible, involving the encryption of job IDs, partition IDs, and other relevant information. This encrypted metadata is then transferred over the network to the destination. The encryption process is necessary because, without knowledge of which specific job the data belongs to, the destination cannot fetch and decrypt the data. This is particularly important for accelerators sitting next to memory, which need to read the decrypted data, perform operations, and write the data back. Thus, the additional information provided by the metadata must be packaged and sent over the network.

For a system comprising multiple compute tiles and memory components which are connected using a scalable network, the VEGAS system provides a mechanism to perform isolated job execution without interfering with standard software tools and models. In essence, assuming a 256-bit true GAS implementation, each “job” in the machine would be exposed to a 64-bit address space for all data belonging to that job, no matter how it is attributed across the physical machine. The other address bits [255:65] would encode a larger address space, where the upper bits are meta-data. It is understood that this is only an example meant for purposes of illustration and is not meant to be limiting. Other bits may be used. This limits every single job to a maximum of approximately 4 ExaBytes (EB) of data for direct access with load/store/atomic operations. One example for how this data might be encoded at the full level is shown in FIG. 2.

The meta-data fields (all fields not including the address fields in FIG. 2) encode information such as user identification and/or access control list (ACL) properties, media type, access interleaving granularity, security rules, encryption requirements and isolation by job key, etc. With second-level re-translation of the extended address space, this extended address may be self-local due to properties such as inter-leaving or resiliency attributes expressed in the access pattern. Metadata fields can be selected as required by the applications. For example, interleaving bits can be removed if it is data is not interleaved. Flexibility to include metadata fields help in reducing packet size and hence system performance.

Descriptions of each of the proposed metadata examples are as follows:

Ruleset represents security levels or rules for concurrent accesses to common data. This may be data shared between user jobs, debuggers, or profilers.

Global Job ID represents an operating system's generated ID associated with the job making the request. This is unique and shared amongst resources dedicated to the job. This job ID becomes an “index” to a transparent global key table for auto-encryption. When implemented in the system, data yet to be encrypted will only exist in the core tile (and be observed as plain text). When in the core tile only resources assigned with the same job ID can understand the content. Once the data leaves the core tile (and passes through the VEGAS encryption block) it will only be seen as ciphertext.

The partition ID is the representation of the nature of potentially compound memory types being used to represent a region of memory—NVM, scratchpad, DRAM, etc.

Interleaving represents granularity of access which can be made dynamic based on memory type. For example, NVM can be interleaved at higher granularity as compared to scratchpads sitting closer to compute units.

The decryption key index or decryption key can also be embedded as part of metadata as ciphertext.

It is understood that the above descriptions are for purposes of illustration and are not meant to be limiting.

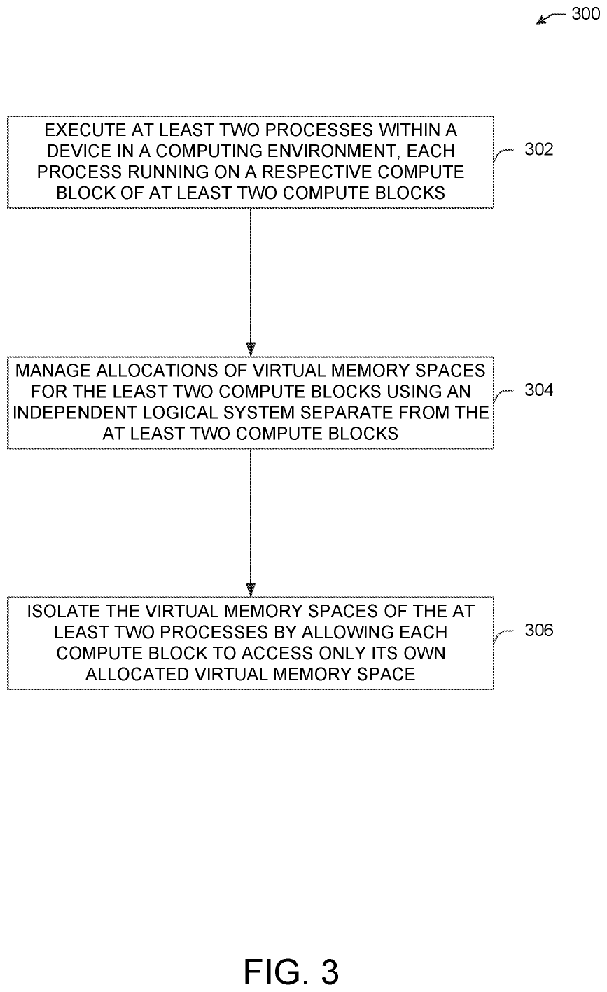

FIG. 3 illustrates a flow diagram of process 300 for an illustrative computing system, in accordance with one or more example embodiments of the present disclosure.

In one or more embodiments, the computing system in question incorporates a computing system that facilitates process isolation between at least two processes running on their respective compute blocks. This process isolation ensures that each job has access only to resources specifically allocated to it, providing a secure computing environment.

At block 302, a computing system may execute at least two processes within a device in a computing environment, each process running on a respective compute block of at least two compute blocks.

At block 304, the computing system may manage allocations of virtual memory spaces for the least two compute blocks using an independent logical system separate from the at least two compute blocks.

At block 306, the computing system may isolate the virtual memory spaces of the at least two processes by allowing each compute block to access only its own allocated virtual memory space.

In addition to process isolation, the computing system includes computer-executable instructions that generate metadata for each process. This metadata is attached to a virtual address space and remains invisible to the compute blocks. Furthermore, the processing circuitry is configured to protect the system network from side-channel attacks by ensuring that each compute block remains unaware of the physical memory information.

The computing system also manages a Global Address Space (GAS), which consists of several address bits. Each job in the computing environment is exposed to the first address bits for all data belonging to that job. Other address bits within the GAS encode an extended address space that includes metadata fields such as user identification, access control list properties, media type, access interleaving granularity, security rules, and encryption requirements.

The computing system comprises components for performing various tasks, including virtual address translation, job isolation, metadata field management, data encryption and decryption, and access rule checks and security management. Additionally, the processing circuitry is configured to allow flexible selection of metadata fields to help reduce packet size and improve overall system performance.

It is understood that the above descriptions are for purposes of illustration and are not meant to be limiting.

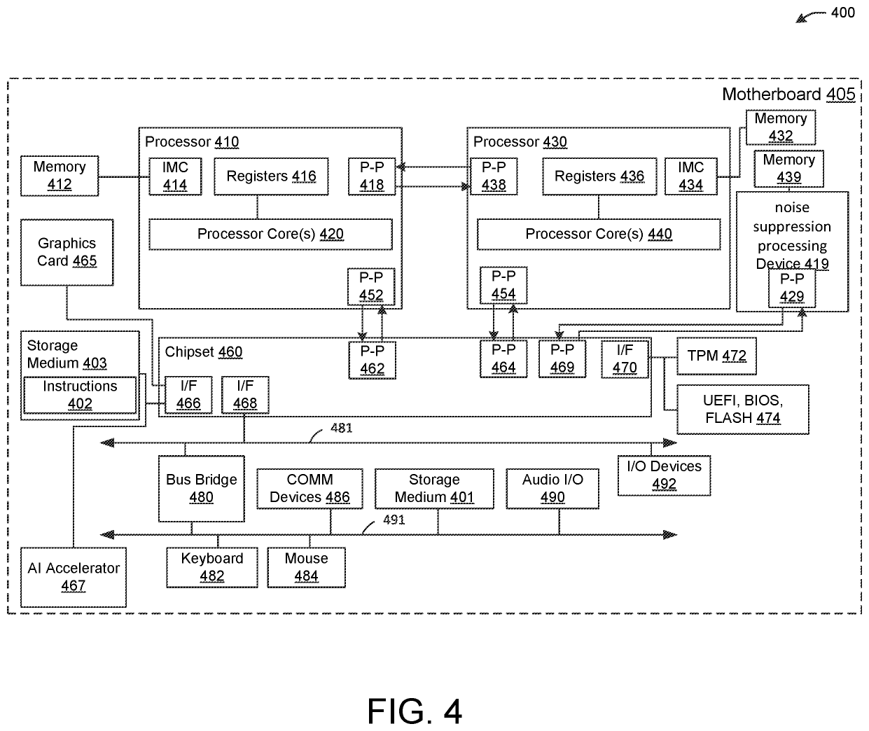

FIG. 4 illustrates an embodiment of an exemplary system 400, in accordance with one or more example embodiments of the present disclosure.

In various embodiments, the computing system 400 may comprise or be implemented as part of an electronic device. The embodiments are not limited in this context. More generally, the computing system 400 is configured to implement all logic, systems, processes, logic flows, methods, equations, apparatuses, and functionality described herein.

The system 400 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 400 may have a single processor with one core or more than one processor. Note that the term “processor” refers to a processor with a single core or a processor package with multiple processor cores.

The computing system 400 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 400. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 400 comprises a motherboard 405 for mounting platform components. The motherboard 405 is a point-to-point interconnect platform that includes a processor 410, a processor 430 coupled via a point-to-point interconnects as an Ultra Path Interconnect (UPI), and a VEGAS device 419. In other embodiments, the system 400 may be of another bus architecture, such as a multi-drop bus. Furthermore, each of processors 410 and 430 may be processor packages with multiple processor cores. As an example, processors 410 and 430 are shown to include processor core(s) 420 and 440, respectively. While the system 400 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 410 and the chipset 460. Some platforms may include additional components and some platforms may only include sockets to mount the processors and/or the chipset.

The processors 410 and 430 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 410, and 430.

The processor 410 includes an integrated memory controller (IMC) 414, registers 416, and point-to-point (P-P) interfaces 418 and 452. Similarly, the processor 430 includes an IMC 434, registers 436, and P-P interfaces 438 and 454. The WIC's 414 and 434 couple the processors 410 and 430, respectively, to respective memories, a memory 412 and a memory 432. The memories 412 and 432 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 412 and 432 locally attach to the respective processors 410 and 430.

In addition to the processors 410 and 430, the system 400 may include a VEGAS device 419. The VEGAS device 419 may be connected to chipset 460 by means of P-P interfaces 429 and 469. The VEGAS device 419 may also be connected to a memory 439. In some embodiments, the VEGAS device 419 may be connected to at least one of the processors 410 and 430. In other embodiments, the memories 412, 432, and 439 may couple with the processor 410 and 430, and the VEGAS device 419 via a bus and shared memory hub.

System 400 includes chipset 460 coupled to processors 410 and 430. Furthermore, chipset 460 can be coupled to storage medium 403, for example, via an interface (I/F) 466. The OF 466 may be, for example, a Peripheral Component Interconnect-enhanced (PCI-e). The processors 410, 430, and the VEGAS device 419 may access the storage medium 403 through chipset 460.

Storage medium 403 may comprise any non-transitory computer-readable storage medium or machine-readable storage medium, such as an optical, magnetic or semiconductor storage medium. In various embodiments, storage medium 403 may comprise an article of manufacture. In some embodiments, storage medium 403 may store computer-executable instructions, such as computer-executable instructions 402 to implement one or more of processes or operations described herein, (e.g., process XZY00 of FIG. XZY). The storage medium 403 may store computer-executable instructions for any equations depicted above. The storage medium 403 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 410 couples to a chipset 460 via P-P interfaces 452 and 462 and the processor 430 couples to a chipset 460 via P-P interfaces 454 and 464. Direct Media Interfaces (DMIs) may couple the P-P interfaces 452 and 462 and the P-P interfaces 454 and 464, respectively. The DMI may be a high-speed interconnect that facilitates, e.g., eight Giga Transfers per second (GT/s) such as DMI 3.0. In other embodiments, the processors 410 and 430 may interconnect via a bus.

The chipset 460 may comprise a controller hub such as a platform controller hub (PCH). The chipset 460 may include a system clock to perform clocking functions and include interfaces for an I/O bus such as a universal serial bus (USB), peripheral component interconnects (PCIs), serial peripheral interconnects (SPIs), integrated interconnects (I2C₅), and the like, to facilitate connection of peripheral devices on the platform. In other embodiments, the chipset 460 may comprise more than one controller hub such as a chipset with a memory controller hub, a graphics controller hub, and an input/output (I/O) controller hub.

In the present embodiment, the chipset 460 couples with a trusted platform module (TPM) 472 and the UEFI, BIOS, Flash component 474 via an interface (I/F) 470. The TPM 472 is a dedicated microcontroller designed to secure hardware by integrating cryptographic keys into devices. The UEFI, BIOS, Flash component 474 may provide pre-boot code.

Furthermore, chipset 460 includes the OF 466 to couple chipset 460 with a high-performance graphics engine, graphics card 465. In other embodiments, the system 400 may include a flexible display interface (FDI) between the processors 410 and 430 and the chipset 460. The FDI interconnects a graphics processor core in a processor with the chipset 460.

Various I/O devices 492 couple to the bus 481, along with a bus bridge 480 which couples the bus 481 to a second bus 491 and an OF 468 that connects the bus 481 with the chipset 460. In one embodiment, the second bus 491 may be a low pin count (LPC) bus. Various devices may couple to the second bus 491 including, for example, a keyboard 482, a mouse 484, communication devices 486, a storage medium 401, and an audio I/O 490.

The artificial intelligence (AI) accelerator 467 may be circuitry arranged to perform computations related to AI. The AI accelerator 467 may be connected to storage medium 403 and chipset 460. The AI accelerator 467 may deliver the processing power and energy efficiency needed to enable abundant-data computing. The AI accelerator 467 is a class of specialized hardware accelerators or computer systems designed to accelerate artificial intelligence and machine learning applications, including artificial neural networks and machine vision. The AI accelerator 467 may be applicable to algorithms for robotics, internet of things, other data-intensive and/or sensor-driven tasks.

Many of the I/O devices 492, communication devices 486, and the storage medium 401 may reside on the motherboard 405 while the keyboard 482 and the mouse 484 may be add-on peripherals. In other embodiments, some or all the I/O devices 492, communication devices 486, and the storage medium 401 are add-on peripherals and do not reside on the motherboard 405.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Example 1 may include a device comprising processing circuitry coupled to storage, the processing circuitry configured to: execute at least two processes within a device in a computing environment, each process running on a respective compute block of at least two compute blocks; manage allocations of virtual memory spaces for the least two compute blocks using an independent logical system separate from the at least two compute blocks; and isolate the virtual memory spaces of the at least two processes by allowing each compute block to access only its own allocated virtual memory space.

Example 2 may include the device of example 1 and/or some other example herein, wherein isolating the virtual memories enables each job to only have access to resources specifically allocated to each job.

Example 3 may include the device of example 1 and/or some other example herein, wherein the processing circuitry may be further configured to generate metadata for each process, wherein the metadata may be attached to a virtual address space and may be not accessible to a compute block.

Example 4 may include the device of example 1 and/or some other example herein, wherein the processing circuitry may be further configured to protect a system network from side channel attacks by ensuring that each compute block remains unaware of physical memory information.

Example 5 may include the device of example 1 and/or some other example herein, wherein the independent logical system manages a Global Address Space (GAS) comprised of a number of address bits, wherein a job in the computing environment may be exposed to first address bits for all data belonging to the job.

Example 6 may include the device of example 5 and/or some other example herein, wherein other address bits of the GAS encode an extended address space comprising metadata fields, wherein the metadata fields include at least one of user identification, access control list properties, media type, access interleaving granularity, security rules, and encryption requirements.

Example 7 may include the device of example 1 and/or some other example herein, wherein the independent logical system comprises components for performing virtual address translation, job isolation, metadata field management, data encryption and decryption, and access rule checks and security management.

Example 8 may include the device of example 1 and/or some other example herein, wherein the processing circuitry may be further configured to enable flexible selection of metadata fields to help in reducing packet size and improve system performance.

Example 9 may include a non-transitory computer-readable medium storing computer-executable instructions which when executed by one or more processors result in performing operations comprising: executing at least two processes within a device in a computing environment, each process running on a respective compute block of at least two compute blocks; managing allocations of virtual memory spaces for the least two compute blocks using an independent logical system separate from the at least two compute blocks; and isolating the virtual memory spaces of the at least two processes by allowing each compute block to access only its own allocated virtual memory space.

Example 10 may include the non-transitory computer-readable medium of example 9 and/or some other example herein, wherein isolating the virtual memories enables each job to only have access to resources specifically allocated to each job.

Example 11 may include the non-transitory computer-readable medium of example 9 and/or some other example herein, wherein the operations further comprise generating metadata for each process, wherein the metadata may be attached to a virtual address space and may be not accessible to a compute block.

Example 12 may include the non-transitory computer-readable medium of example 9 and/or some other example herein, wherein the operations further comprise protect a system network from side channel attacks by ensuring that each compute block remains unaware of physical memory information.

Example 13 may include the non-transitory computer-readable medium of example 9 and/or some other example herein, wherein the independent logical system manages a Global Address Space (GAS) comprised of a number of address bits, wherein a job in the computing environment may be exposed to first address bits for all data belonging to the job.

Example 14 may include the non-transitory computer-readable medium of example 13 and/or some other example herein, wherein other address bits of the GAS encode an extended address space comprising metadata fields, wherein the metadata fields include at least one of user identification, access control list properties, media type, access interleaving granularity, security rules, and encryption requirements.

Example 15 may include the non-transitory computer-readable medium of example 9 and/or some other example herein, wherein the independent logical system comprises components for performing virtual address translation, job isolation, metadata field management, data encryption and decryption, and access rule checks and security management.

Example 16 may include the non-transitory computer-readable medium of example 9 and/or some other example herein, wherein the operations further comprise enable flexible selection of metadata fields to help in reducing packet size and improve system performance.

Example 17 may include a method comprising: executing at least two processes within a device in a computing environment, each process running on a respective compute block of at least two compute blocks; managing allocations of virtual memory spaces for the least two compute blocks using an independent logical system separate from the at least two compute blocks; and isolating the virtual memory spaces of the at least two processes by allowing each compute block to access only its own allocated virtual memory space.

Example 18 may include the method of example 17 and/or some other example herein, wherein isolating the virtual memories enables each job to only have access to resources specifically allocated to each job.

Example 19 may include the method of example 17 and/or some other example herein, further comprising generating metadata for each process, wherein the metadata may be attached to a virtual address space and may be not accessible to a compute block.

Example 20 may include the method of example 17 and/or some other example herein, further comprising protect a system network from side channel attacks by ensuring that each compute block remains unaware of physical memory information.

Example 21 may include the method of example 17 and/or some other example herein, wherein the independent logical system manages a Global Address Space (GAS) comprised of a number of address bits, wherein a job in the computing environment may be exposed to first address bits for all data belonging to the job.

Example 22 may include the method of example 21 and/or some other example herein, wherein other address bits of the GAS encode an extended address space comprising metadata fields, wherein the metadata fields include at least one of user identification, access control list properties, media type, access interleaving granularity, security rules, and encryption requirements.

Example 23 may include the method of example 17 and/or some other example herein, wherein the independent logical system comprises components for performing virtual address translation, job isolation, metadata field management, data encryption and decryption, and access rule checks and security management.

Example 24 may include the method of example 17 and/or some other example herein, further comprising enable flexible selection of metadata fields to help in reducing packet size and improve system performance.

Example 25 may include an apparatus comprising means for: executing at least two processes within a device in a computing environment, each process running on a respective compute block of at least two compute blocks; managing allocations of virtual memory spaces for the least two compute blocks using an independent logical system separate from the at least two compute blocks; and isolating the virtual memory spaces of the at least two processes by allowing each compute block to access only its own allocated virtual memory space.

Example 26 may include the apparatus of example 25 and/or some other example herein, wherein isolating the virtual memories enables each job to only have access to resources specifically allocated to each job.

Example 27 may include the apparatus of example 25 and/or some other example herein, further comprising generating metadata for each process, wherein the metadata may be attached to a virtual address space and may be not accessible to a compute block.

Example 28 may include the apparatus of example 25 and/or some other example herein, further comprising protect a system network from side channel attacks by ensuring that each compute block remains unaware of physical memory information.

Example 29 may include the apparatus of example 25 and/or some other example herein, wherein the independent logical system manages a Global Address Space (GAS) comprised of a number of address bits, wherein a job in the computing environment may be exposed to first address bits for all data belonging to the job.

Example 30 may include the apparatus of example 29 and/or some other example herein, wherein other address bits of the GAS encode an extended address space comprising metadata fields, wherein the metadata fields include at least one of user identification, access control list properties, media type, access interleaving granularity, security rules, and encryption requirements.

Example 31 may include the apparatus of example 25 and/or some other example herein, wherein the independent logical system comprises components for performing virtual address translation, job isolation, metadata field management, data encryption and decryption, and access rule checks and security management.

Example 32 may include the apparatus of example 25 and/or some other example herein, further comprising enable flexible selection of metadata fields to help in reducing packet size and improve system performance.

Example 33 may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Example 34 may include an apparatus comprising logic, modules, and/or circuitry to perform one or more elements of a method described in or related to any of examples 1-32, or any other method or process described herein.

Example 35 may include a method, technique, or process as described in or related to any of examples 1-32, or portions or parts thereof.

Example 36 may include an apparatus comprising: one or more processors and one or more computer readable media comprising instructions that, when executed by the one or more processors, cause the one or more processors to perform the method, techniques, or process as described in or related to any of examples 1-32, or portions thereof.

Example 37 may include a method of communicating in a wireless network as shown and described herein.

Example 38 may include a system for providing wireless communication as shown and described herein.

Example 39 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A computing system comprising:
at least one memory that stores computer-executable instructions; and
at least one processor configured to access the at least one memory and execute the computer-executable instructions to:
execute at least two processes within a device in a computing environment, each process running on a respective compute block of at least two compute blocks;
manage allocations of virtual memory spaces for the least two compute blocks using an independent logical system separate from the at least two compute blocks; and
isolate the virtual memory spaces of the at least two processes by allowing each compute block to access only its own allocated virtual memory space.

2. The computing system of claim 1, wherein the process isolation ensures that each job only has access to resources specifically allocated to each job.

3. The computing system of claim 1, further comprising computer-executable instructions to generate metadata for each process, wherein the metadata is attached to a virtual address space and is not accessible to a compute block.

4. The computing system of claim 1, wherein the computer-executable instructions is further configured to protect the system network from side channel attacks by ensuring that each compute block remains unaware of physical memory information.

5. The computing system of claim 1, wherein the independent logical system manages a Global Address Space (GAS) comprised of a number of address bits, wherein a job in the computing environment is exposed to first address bits for all data belonging to the job.

6. The computing system of claim 5, wherein other address bits of the GAS encode an extended address space comprising metadata fields, wherein the metadata fields include at least one of user identification, access control list properties, media type, access interleaving granularity, security rules, and encryption requirements.

7. The computing system of claim 1, wherein the independent logical system comprises components for performing virtual address translation, job isolation, metadata field management, data encryption and decryption, and access rule checks and security management.

8. The computing system of claim 1, wherein the computer-executable instructions is further configured to enable flexible selection of metadata fields to help in reducing packet size and improve system performance.

9. A non-transitory computer-readable medium storing computer-executable instructions which when executed by one or more processors result in performing operations comprising:
executing at least two processes within a device in a computing environment, each process running on a respective compute block of at least two compute blocks;
managing allocations of virtual memory spaces for the least two compute blocks using an independent logical system separate from the at least two compute blocks; and
isolating the virtual memory spaces of the at least two processes by allowing each compute block to access only its own allocated virtual memory space.

10. The non-transitory computer-readable medium of claim 9, wherein isolating the virtual memories enables each job to only have access to resources specifically allocated to each job.

11. The non-transitory computer-readable medium of claim 9, wherein the operations further comprise generating metadata for each process, wherein the metadata is attached to a virtual address space and is not accessible to a compute block.

12. The non-transitory computer-readable medium of claim 9, wherein the operations further comprise protecting a system network from side channel attacks by ensuring that each compute block remains unaware of physical memory information.

13. The non-transitory computer-readable medium of claim 9, wherein the independent logical system manages a Global Address Space (GAS) comprised of a number of address bits, wherein a job in the computing environment is exposed to first address bits for all data belonging to the job.

14. The non-transitory computer-readable medium of claim 13, wherein other address bits of the GAS encode an extended address space comprising metadata fields, wherein the metadata fields include at least one of user identification, access control list properties, media type, access interleaving granularity, security rules, and encryption requirements.

15. The non-transitory computer-readable medium of claim 9, wherein the independent logical system comprises components for performing virtual address translation, job isolation, metadata field management, data encryption and decryption, and access rule checks and security management.

16. The non-transitory computer-readable medium of claim 9, wherein the operations further comprise enable flexible selection of metadata fields to help in reducing packet size and improve system performance.

17. A method comprising:
executing at least two processes within a device in a computing environment, each process running on a respective compute block of at least two compute blocks;
managing allocations of virtual memory spaces for the least two compute blocks using an independent logical system separate from the at least two compute blocks; and
isolating the virtual memory spaces of the at least two processes by allowing each compute block to access only its own allocated virtual memory space.

18. The method of claim 17, wherein isolating the virtual memories enables each job to only have access to resources specifically allocated to each job.

19. The method of claim 17, further comprising generating metadata for each process, wherein the metadata is attached to a virtual address space and is not accessible to a compute block.

20. The method of claim 17, further comprising protecting a system network from side channel attacks by ensuring that each compute block remains unaware of physical memory information.
